(19) United States
(12) Patent Application Publication
(10) Pub. No.: US 2024/0200942 A1
(43) Pub. Date: Jun. 20, 2024

(54) METHOD OF DETERMINING A FREE SURFACE ELEVATION OF A WATER BODY USING A RADAR AND A DRONE

(71) Applicant: IFP Energies nouvelles, RUEIL-MALMAISON (FR)

(72) Inventors: Alexis MERIGAUD, RUEIL-MALMAISON CEDEX (FR); Paolino TONA, RUEIL-MALMAISON CEDEX (FR)

(21) Appl. No.: 18/534,778

(22) Filed: Dec. 11, 2023

(30) Foreign Application Priority Data
Dec. 16, 2022 (FR) 2213588

(51) Int. Cl. G01C 13/00

(52) U.S. Cl. CPC G01C 13/004

(57) ABSTRACT

The present invention is a method of determining a free surface elevation (ESL) of a water body zone. The method involves measurement by radar (MRA) and localized measurement using a drone (MDR) equipped with a sensor, in order to calibrate (CAL) a free surface elevation reconstruction model (MOD) in the considered zone. The calibrated model (MOD CAL) is subsequently applied to real-time radar measurements (MRA) in order to determine free surface elevation (ESL).

### CROSS-REFERENCE TO RELATED APPLICATION

Reference is made to French Patent Application No. 2213588 filed Dec. 16, 2022, which is incorporated herein by reference in its entirety.

### BACKGROUND OF THE INVENTION

### Field of the Invention

The present invention concerns the field of wave characterization, in particular for monitoring, operation and control of a system subject to waves, whether floating or not.

### DESCRIPTION OF THE PRIOR ART

Free water surface elevation time series are notably used to characterize waves within a water body (sea, ocean, lake for example). This free surface elevation gives the water height (therefore the wave height) in relation to a situation where the surface is undisturbed (flat sea for example) at any point of the water surface. Free surface elevation measurement is a common issue for responding to various challenges. A first challenge is fine characterization (at individual wave scale) of the sea state, which is most often characterized by descriptions of the statistical distribution of individual wave heights, such as spectrum, significant height and average period. These descriptors are commonly used for navigation monitoring, sea operations monitoring, energy production platform monitoring, marine energy exploitation site monitoring. A free surface elevation measurement not only allow performing more accurate statistical characterizations, but it also allows short-term predictions (from a few seconds to a few minutes) for the swell height and the resulting movements of a floating system. These predictions allow for example to detect the arrival of a train of potentially dangerous waves for a given operation (transfer of personnel to a wind turbine or a vessel for example) or, on the contrary, a period of calm allowing the operation in question to be carried out. Another challenge related to wave and swell predictions made from the free surface elevation is floating system control (notably using predictive control): for example, to provide stabilization of a ship, motion compensation, heave compensation for example (which may be interesting for a floating oil production platform), real-time control of floating wind turbines or wave energy converters (notably in order to maximize the energy produced and/or to decrease the fatigue of the components of such systems).

Several technologies have been developed to measure and to determine the free surface elevation.

Some of these solutions allow measurement of a resultant characteristic of the waves or swell at only one measuring point, using an instrumented buoy for example, which does not provide an indication of the free surface elevation at any point of a water body zone.

Marine radars, X-band radars for example, which are found on all large ships and many offshore facilities, are a particularly interesting technology for remote wave measurement, although they were initially intended rather for navigation and collision avoidance. The images provided by marine radars not only detect targets or obstacles such as ships and coastlines, but also reflections from the sea surface known as “sea clutter”, caused by the interaction between the radar waves and ripples on the surface, generated by the wind. The backscatter of this rough surface reveals the underlying shape of the waves. With appropriate processing, it is in principle possible to perform wave measurements over a wide field of view (up to about 5 km range, depending on the installation height of the radar antenna and on the sea state), with a good spatial resolution (of the order of 5 m in distance and 1° azimuth) and sufficient temporal resolution (an image every 1 to 3 seconds) to monitor the waves individually.

More precisely, the principle of wave measurement by radar is as follows: the electromagnetic waves emitted by the radar interact, according to Bragg's law, with the sea surface ripples (height variations) whose wavelength is of the order of a centimeter (like the radar waves). The result is a backscattered signal, the sea clutter, which returns to the radar receiver, whose intensity is modulated by the waves (which may be between about ten and about a hundred meters long) via a variety of mechanisms that are not all yet fully understood. The radar images therefore show patterns that look like waves, and from which the latter can theoretically be reconstructed, via suitable processing.

Radar images can provide sea state estimates, which are statistical information on the wave height, and the energy content thereof depending on frequency and direction. They should also allow going much further, with a true “wave by wave” reconstruction of the free surface elevation (ESL), like a three-dimensional film of the sea surface. Such a wave by wave reconstruction, with the wide range and the radar resolution, lends itself to many applications. It is notably ideal for monitoring purposes in the field of marine renewable energies, and it paves the way for real-time wave or ship motion prediction, over timeframes of several minutes, thus allowing the feasibility and safety of a large number of sea operations to be improved.

However, despite their promising prospects, radars only provide a very indirect measurement of the waves, via images, or intensity signals, of the sea clutter. The sea clutter intensity is modulated by the orbital velocity of the fluid at the surface and the angle of incidence of the radar beam on the sea surface, which may be linearly related to the free surface elevation to be measured. Other wave-related factors make this modulation more complex. In particular these are shadow effects (when some zones of the sea surface are geometrically hidden by waves closer to the radar), or the presence of microbreaking waves. In addition to these wave-induced modulations, other factors alter the signal due to the waves, in particular the function of amplification of the signal received by the radar, the presence of speckle noise, or meteorological factors such as rain or sea spray, which may generate backscatter.

To overcome this problem, the reconstruction of waves from radar images is generally based on the “standard method” that is notably described in the following documents:
Young, I. R., Rosenthal, W., & Ziemer, F. (1985). A Three-Dimensional Analysis of Marine Radar Images for the Determination of Ocean Wave Directionality and Surface Currents. Journal of Geophysical Research: Oceans, 90(C1), 1049-1059.
Nieto Borge, J., Rodriguez, G. R., Hessner, K., & Gonzilez, P. I. (2004). Inversion of Marine Radar Images for Surface Wave Analysis. Journal of Atmospheric and Oceanic Technology, 21(8), 1291-1300.

This method does not use an explicit radar image formation (and inversion) model: in this approach, the field of view of the radar is divided into rectangular areas in which a three-dimensional Fourier transform of the signal is applied. The wave-related signal components are then identified and filtered using the dispersion relation for gravity waves that relates frequency to wavelength. Then consider that the components thus obtained are linearly related to the components of the free surface elevation signal. Finally, the reconstructed signal still requires amplitude calibration in order to obtain sea state images with the correct energy. As can be seen, the standard method avoids detailed knowledge of the image formation mechanisms, and it is based on a significant number of empirical parameters, such as the filtering parameters, the modulation transfer function parameters and the amplitude calibration parameters. Optimizing or checking these parameters can rely on the use of additional sensors, such as instrumented buoys, the IMU of a ship, laser remote detection (LiDAR sensor) or a microseismic wave sensor on shore. Another option uses coherent radars that also detect the Doppler signal due to surface movement. Indeed, the Doppler velocity can, in principle, be used to reconstruct the free surface elevation without going through the calibration step via a modulation transfer function. However, to obtain stable Doppler signals, the radar needs to observe the same points over a relatively long period, which makes the proposed measurement procedure rather complex.

Furthermore, the vast majority of the current marine radars do not have this feature. Using additional measurements is therefore necessary or, at least, recommended, to obtain an accurate wave field reconstruction from radar measurements.

Furthermore, the method described in patent application FR-3,108,152 (WO2021/180,502) uses one or more sensors (for example radar, LiDAR, accelerometer, displacement sensor, pressure sensor, etc.) measuring the free surface elevation of the swell or resulting characteristics at one or more points, and swell or resultant swell characteristic predictions are deduced therefrom using transfer functions. This method provides good prediction of a swell resultant, but it does not allow the free surface elevation to be determined at any point of a zone from a radar signal.

### SUMMARY OF THE INVENTION

The invention determines in real time the free surface elevation at any point of a water body zone, in an accurate and simple manner. The invention therefore concerns a method of determining a free surface elevation of a water body zone. The method involves (distributed) measurement by radar and localized measurement using a drone equipped with a sensor, in order to calibrate a free surface elevation reconstruction model in the zone being considered. This calibrated model is subsequently applied to real-time radar measurements in order to determine the free surface elevation. The drone enables localized precise measurement, which allows calibration of the model with an accurate value and makes the model more accurate. Moreover, the drone can perform measurements in areas inaccessible or hard to access by radar (for example due to meteorological conditions, or to the presence of shadows or objects on the water body). Moreover, using a drone allows varying of the position of the measuring points (the measuring points are not fixed). It is therefore possible to adapt the calibration according to the conditions encountered.

The invention also concerns a system for determining a free surface elevation, and one or more methods of monitoring, operating or controlling a system subject to waves implementing such a method.

The invention concerns a method of determining an elevation of a free surface of a water body zone using a radar and at least one drone equipped with at least one sensor for remote measurement of the free surface elevation. For this method, the following steps are carried out:
a. building (constructing) a free surface elevation reconstruction model, the model relating a signal of the radar to the free surface elevation;
b. measuring a signal representative of the free surface elevation of the water body zone using the radar;
c. flying the at least one drone to perform at least one localized measurement at a measuring point of the water body zone using the sensor fitted in the at least one drone;
d. calibrating the free surface elevation reconstruction model by use of the at least one localized measurement; and
e. applying the calibrated free surface elevation reconstruction model to a signal representative of the free surface measured by the radar, in order to determine the free surface elevation of the water body zone.

According to an embodiment, the at least one measuring point is defined as a function of the signal measured by the radar.

Advantageously, at least one meteorological condition is acquired, and the free surface elevation reconstruction model is a function of the at least one meteorological condition, preferably the at least one meteorological condition is selected from among the wind speed, the wind direction, the rainfall, the temperature and the sea state.

According to an aspect, the sensor fitted in the at least one drone is selected from among a LiDAR sensor, a thermal camera, an optical camera, and a vertical-beam radar.

According to an implementation, the free surface elevation reconstruction model is built using a modulation transfer function, an assimilation method, a machine learning method or a deep learning method.

According to an embodiment option, the steps of flying the at least one drone and of offline calibration are carried out, and the calibrated free surface elevation reconstruction model is applied to a signal measured by the radar online.

According to an embodiment option, the steps of flying the at least one drone and of online calibration are carried out, so as to calibrate the free surface elevation reconstruction model on a continuous basis.

Advantageously, the free surface elevation is determined in real time.

Furthermore, the invention concerns a system for determining the free surface elevation of a zone of a water body, comprising at least one radar, at least one drone equipped with at least one sensor for remote free surface elevation measurement, a system for flying the at least one drone and computing for implementing the method of determining the free surface elevation according to one of the above features.

The invention further concerns a method of monitoring, operating or controlling a system subject to waves within a water body, comprising steps of:
a. determining free surface elevation of the water body by use of a method of determining the free surface elevation according to one of the above features; and
b. supervising, operating or controlling the system subject to waves as a function of the free surface elevation of the determined water body.

### BRIEF DESCRIPTION OF THE DRAWINGS

Other features and advantages of the method and of the system according to the invention will be clear from reading the description hereafter of embodiments given by way of non-limitative example, with reference to the accompanying figures wherein:

FIG. 1 illustrates the steps of the method of determining a free surface elevation according to a first embodiment of the invention;

FIG. 2 illustrates the steps of the method of determining a free surface elevation according to a second embodiment of the invention;

FIG. 3 illustrates the steps of the method of determining a free surface elevation according to a third embodiment of the invention;

FIG. 4 illustrates the steps of the method of determining a free surface elevation according to a first implementation of the third embodiment of the invention;

FIG. 5 illustrates the steps of the method of determining a free surface elevation according to a second implementation of the third embodiment of the invention;

FIG. 6 illustrates a reference free surface elevation and a signal obtained by a radar, for a simulated illustrative example;

FIG. 7 illustrates a free surface elevation reconstructed from a radar sensor by use of a method according to the prior art, and a reference free surface elevation, for the example of FIG. 6;

FIG. 8 illustrates, with angles and distances, the modulus and the phase of the modulation transfer function determined by applying the method according to the prior art as in FIGS. 6 and 7; and

FIG. 9 illustrates, with several angles and several distances, the free surface elevation height as a function of time, determined using several methods, for an application example.

### DETAILED DESCRIPTION OF THE EMBODIMENTS

The invention concerns a method of determining the free surface elevation of a zone of a water body. It is understood that the free surface elevation is the water height at a point of a water body in relation to the water surface that would have no variation in height (thus remaining totally undisturbed). The free surface elevation therefore reflects the height of the waves or the swell. A water body may be a sea, an ocean, a lake, a river, etc. The zone considered by the method according to the invention is a zone of interest, notably for monitoring, operating or controlling a system subject to waves. The extent of this zone of interest can depend on the system subject to waves. As a variant, the extent of this zone of interest can correspond to the measurement zone of the radar used in the method.

The method according to the invention uses at least one radar and at least one drone equipped with at least one sensor for remote measurement of the free surface elevation.

For this method, the following steps are carried out:
1) Building (constructing) a free surface elevation reconstruction model
2) Indirect wave measurement by radar
3) Drone flight and localized measurement
4) Calibrating the free surface elevation reconstruction model
5) Determining the free surface elevation.

Steps 1 and 3 to 5 can be carried out by computers, notably a computer, a server or a calculator. The computer comprise at least one processor and at least one computer memory. Step 1 can be carried out a single time before, during or after steps 2 and 3. The steps are detailed in the rest of the description below.

According to an embodiment of the invention, determining the free surface elevation of the water body zone can be done in real time. Thus, if necessary, a system subject to waves can be monitored, operated or controlled in real time. For this embodiment, a radar measurement step is carried out in real time. In real time devices that the measurement is available as soon as it has been taken.

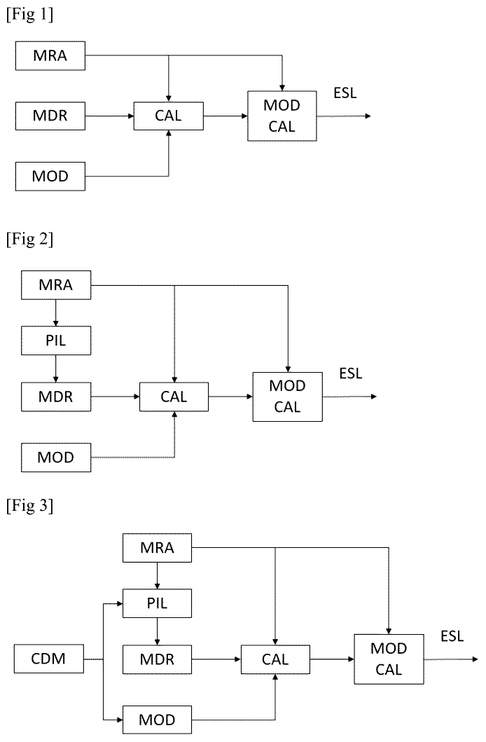

FIG. 1 schematically illustrates, by way of non-limitative example, the steps of the method according to a first embodiment of the invention. A free surface elevation reconstruction model MOD is first formed. A measurement is then performed by use of the radar MRA. A drone MDR is subsequently used and a localized free surface elevation measurement is performed therewith. The radar MRA and drone MDR measurements are used to calibrate CAL free surface elevation reconstruction model MOD. A calibrated free surface elevation reconstruction model MOD CAL is thus formed. This calibrated model MOD CAL is applied to a radar measurement MRA in order to determine a free surface elevation ESL.

According to an embodiment, the drone can be flown at least at one measuring point defined as a function of the radar measurement. For example, according to a zone where the radar measurement is inaccurate, for example due to the presence of a shadow, a structure, etc. Additionally and alternatively, a measuring point can be determined in different areas of the zone of interest so as to try and compensate for the radar measurement variations according to the direction and the distance.

FIG. 2 schematically illustrates, by way of non-limitative example, the steps of the method according to a second embodiment of the invention. Steps identical to the first embodiment of FIG. 1 are not described again. The method comprises a step of flying PIL the drone as a function of radar measurement MRA. This drone flight step PIL allows obtaining the measurement by the sensor of drone MDR at least at one measuring point.

According to an implementation, the method can comprise a step of acquiring at least one meteorological condition (preferably several meteorological conditions). For example, the meteorological condition(s) can be selected from among the wind speed, the wind direction, the rainfall, the temperature, the sea state, etc. The at least one measuring point can then be determined according to the meteorological condition(s). A localized free surface elevation measurement can thus be performed at a point where the radar measurement is affected by the meteorological condition(s).

FIG. 3 schematically illustrates, by way of non-limitative example, the steps of the method according to a third embodiment of the invention. Steps identical to the first embodiment of FIG. 1 and to the second embodiment of FIG. 2 are not described again. The method comprises a step of acquiring at least one meteorological condition CDM. The acquired meteorological condition is used in drone flight step PIL and in the building (constructing) of swell elevation reconstruction model MOD.

According to a first implementation of the invention, the calibration step can be carried out offline. In other words, the calibration step is carried out a single time, then the calibrated model is used online in real time. Thus, a model and a complex calibration can be used to obtain a complete free surface elevation reconstruction model, this complete model being suited to be applied online in real time. For this implementation of the invention, the drone measurement, radar measurement and calibration steps are carried out offline. Another radar measurement is performed online, and the calibrated model is applied online to this online radar measurement.

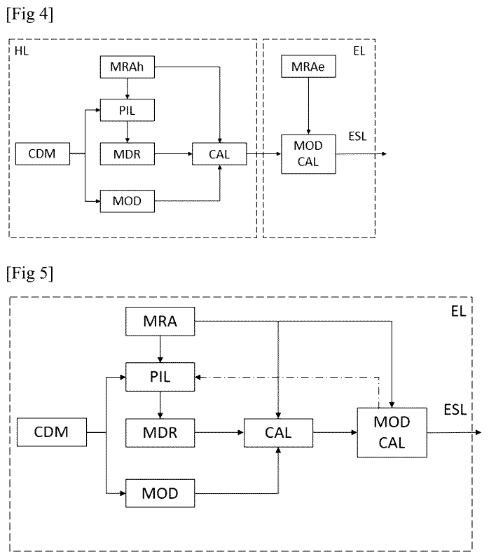

FIG. 4 schematically illustrates, by way of non-limitative example, the steps of the method according to such an implementation. FIG. 4 illustrates this implementation for the third embodiment of FIG. 3. However, this implementation can also be applied to the embodiments of FIGS. 1 and 2. The steps described in connection with the previous figures are not described again. For this implementation, some steps are carried out offline HL, and some are carried out online EL. The offline radar measurement used for calibration is denoted by MRAh, and the online radar measurement used to determine the free surface elevation is denoted by MRAe. Thus, offline HL, the following steps are carried out: radar measurement MRAh, meteorological conditions acquisition CDM, flying the at least one drone PIL, measurement by drone sensor MDR, building (constructing) of the surface elevation reconstruction model MOD and calibration CAL. Online EL, online radar measurement MRAe is carried out, and calibration surface elevation reconstruction model MOD CAL is applied to online radar measurement MRAe.

According to a second implementation of the invention, the calibration step can be carried out online in a continuous manner. In other words, the free surface elevation reconstruction model is continuously calibrated with new drone measurements. Thus, the free surface elevation reconstruction model is adapted in real time with new localized measurements, which allows obtaining an accurate model at any time and at any point of the zone of interest. For this implementation, all the steps are carried out online in real time.

FIG. 5 schematically illustrates, by way of non-limitative example, the steps of the method according to such an implementation. FIG. 5 illustrates this implementation for the third embodiment of FIG. 3. However, this implementation can also be applied to the embodiments of FIGS. 1 and 2. The steps described in connection with the previous figures are not described again. For this implementation, all the steps are carried out online EL: radar measurement MRA, meteorological conditions acquisition CDM, flying the at least one drone PIL, drone sensor measurement MDR, building (constructing) of the surface elevation reconstruction model MOD, calibration CAL are carried out, and calibrated surface elevation reconstruction model MOD CAL is applied. For this implementation, drone flying step PIL can take account of a return of calibrated model MOD CAL to determine at least one of the localized measurements.

### 1) Building (Constructing) a Free Surface Elevation Reconstruction Model

This step builds (constructs) a free surface elevation reconstruction model. Such a free surface elevation reconstruction model relates a measurement signal from a radar to a free surface elevation. In other words, the free surface elevation reconstruction model has, as the input, a radar measurement signal and, as the output, a free surface elevation at any point of a water body zone. For calibration of this model in step 4, the model can depend on at least one parameter, which is adjusted during calibration. As a variant, the model can depend on at least one weighting that is adjusted during calibration.

According to an embodiment of the invention, the free surface elevation reconstruction model can be built using a modulation transfer function MTF. Building such a model does not require a significant number of measurements. The following document describes an example of such a model:
Chen, Z., Zhang, B., He, Y. et al. (2015). A New Modulation Transfer Function for Ocean Wave Spectra Retrieval from X-Band Marine Radar Imagery. Chin. J. Ocean. Limnol. 33, 1132-1141 (2015).

According to an embodiment of the invention, the free surface elevation reconstruction model can be built using data assimilation, that is by minimizing a cost function defined as the difference between the radar measurements and the predictions of a linear or non-linear wave evolution model over a time range referred to as assimilation interval. An example of this approach is given in the following document:
Aragh, Sina & Nwogu, Okey & Lyzenga, David. (2008). Improved Estimation of Ocean Wave Fields from Marine Radars Using Data Assimilation Techniques. Proceedings of the International Offshore and Polar Engineering Conference.

In this case, the parameters of the free surface elevation reconstruction model adjusted during calibration are the parameters of the assimilation method.

According to an embodiment of the invention, the free surface elevation reconstruction model can be built using a machine learning method or a deep learning method. Building such a model does not require a priori knowledge of physical phenomena.

For this embodiment, the following steps can be carried out:
building a learning base that comprises radar measurement signals and free surface elevation measurements, alternatively or cumulatively, the learning base can comprise at least one of simulated radar measurement signals and simulated free surface elevation measurements (this type of simulated measurements is referred to as “synthetic” measurements); and
building a free surface elevation reconstruction model using a machine learning method trained on the learning base thus built, the free surface elevation reconstruction model associating a free surface elevation with a radar measurement signal.

The machine learning method can be supervised or not, such as a neural network, a random forest, a support vector machine, etc. For example, if the model is built using a neural network, then the calibration step can modify some weightings of the neural network.

As a variant, building the surface elevation reconstruction model can be done using any similar method.

Advantageously, building the surface elevation reconstruction model can depend on meteorological conditions. Thus, the model can account for these meteorological conditions to improve the model accuracy. For example, when using the machine learning method, the learning base can further comprise the meteorological conditions.

### 2) Indirect Wave Measurement by Radar

This step measures a signal representative of the free surface elevation of the water body zone by use of a radar. In other words, a measurement of the water body zone is performed by use of the radar. The radar provides an indirect measurement of the free surface elevation on a measurement surface (that may correspond to the zone of interest). An indirect measurement is understood to be a measurement that is correlated to the swell free surface elevation in a complex manner, and which requires a reconstruction procedure to be exploitable. This is notably the case with the radar signal intensity, affected by wave-induced modulations (orbital velocity at the surface, angle of incidence of the radar beam, shadow effects, microbreaking waves, etc.), and by the radar itself (received signal amplification function, speckle noise), etc. The radar measurement signal is the normalized intensity of the signal backscattered by the sea, preferably with as little processing as possible. This signal can be normally available, in digital form, at the output of the latest-generation navigation radars. For this configuration, a digitizing device can be provided to exploit the analog signal sent to a radar screen. The radar can be considered as a two-dimensional indirect measurement of the free surface elevation. Thus, the radar can provide a two-dimensional time series of the free surface elevation.

According to an embodiment, the radar can be an X-band radar. The X band is a segment of the micro-wave region of the electromagnetic spectrum, with a frequency range of 8 to 12 GHz and a wavelength of about 3 cm. An X-band radar allows the measurement to be available as soon as it has been taken. Furthermore, such a radar provides a wide field of view (up to about 5 km range, depending on the installation height of the radar antenna and on the sea state), with a good spatial resolution (of the order of 5 m in distance and 1° azimuth for example) and a good temporal resolution (an image every 1 to 3 seconds for example) to monitor the swell “wave by wave”. Alternatively, the radar can be a radar with bands close to the X band (notably the Ku band, or the S band), with better temporal and/or spatial resolutions, or any similar technology.

According to an aspect, the radar can be a coastal radar or a radar fitted in a floating system, for example a radar fitted in a ship, a floating platform, or a fixed platform.

For the method according to the invention, a real-time radar measurement is performed, for application of the calibrated model. Also, a radar measurement is performed for calibration of the model. This radar measurement for calibration can be performed offline or online, depending on the implementation considered (see the embodiments of FIGS. 4 and 5 described above).

### 3) Drone Flight and Localized Measurement

This step flies the at least one drone for localized measurement of the free surface elevation by use of the sensor fitted in the at least one drone. The localized measurement is carried out at a measuring point of the water body zone. Thus, at least one georeferenced measurement of the free surface elevation is performed for calibration of the reconstruction model.

According to an aspect of the invention, the drone is a flying drone and it comprises at least one sensor for remote measurement of the free surface elevation. The sensor can preferably enable direct measurement of the free surface elevation. A direct measurement is understood to be a directly exploitable measurement of the free surface elevation of waves or swell, provided by a sensor that is calibrated once and for all, and that is subsequently totally autonomous. On the contrary, a radar as used in step 2 provides an indirect measurement. Thus, it may considered that the drone performs a one-dimensional direct measurement of the free surface elevation (measuring point).

According to example embodiments, the sensor provided on the drone can be selected from among a LiDAR sensor (laser remote detection), a thermal camera, an optical camera, a vertical-beam radar, or any similar sensor.

According to an embodiment, the position of each measuring point can be determined in order to improve the free surface elevation reconstruction model. Determination of the position of each measuring point can advantageously be automatic. The position of each measuring point can depend on the measured radar signal, to determine at least one measuring point for which the radar measurement is not accurate, for example due to a shadow, an object, the presence of microbreaking waves, or others. For the embodiment wherein at least one meteorological condition is acquired, the position of each measuring point can be determined as a function of the meteorological condition.

For this embodiment, the drone is operated to be at the vertical of the measuring point and to remain in stationary flight, the time to perform a remote measurement of the free surface elevation, by use of at least one sensor fitted in the drone.

According to an implementation of the invention, the drone can be flown at several altitudes with respect to the water surface level, in order to improve the localized measurement accuracy.

According to an aspect, the method can use localized measurements at a plurality of measuring points, by use of the sensor of a drone, or multiple drones equipped with sensors. Advantageously, a part of the measuring points can be aligned to perform measurements in a determined direction. Preferably, the measuring points in an alignment can be evenly spaced. Advantageously, the measuring points can be distributed over several alignments.

For the implementation where calibration is carried out offline, the drone flight and localized measurement step can be carried out offline, at a single time. Thus, the use of a drone is limited in time, and once calibration is completed, the drone can be applied to another process.

For the implementation where calibration is carried out online, this drone flight and localized measurement step can be carried out continuously and online. Thus, the model can constantly be calibrated, which provides higher accuracy of the calibrated model.

In order to determine the free surface elevation from the sensor fitted in the drone, prior calibration of the measurement taken by the sensor fitted in the drone can be performed. The calibration methodology of the drone-embedded swell measurement system depends on the measuring sensor technology.

According to a first example, if it is a scanning LiDAR sensor, the methodology described in the following document can for example be applied:
Huang, Z., Yeh, C., Tseng, K., and Hsu, W. (2018). A UAV-RTK Lidar System for Wave and Tide Measurements in Coastal Zones. Journal of Atmospheric and Oceanic Technology 35, 8, 1557-1570.

This method is suited for a measurement system having an aerial drone, a LiDAR, an altitude and heading reference system (AHRS) and a real-time kinematic (RTK) global navigation satellite system (GNSS). In this case, calibration of the measuring sensor of the drone is used to obtain the parameters required for conversion of the raw LiDAR data to georeferenced free surface elevation data, and it can be done ashore, by use of repeated measurements on two horizontal plates.

According to a second example, for a drone equipped with a stereoscopic vision measurement system, using the WASS methodology and toolbox described in the following document can be considered:
Bergamasco, F., Torsello, A., Sclavo, M., Barbariol, F., Benetazzo, A. (2017). WASS: An Open-Source Pipeline for 3D Stereo Reconstruction of Ocean Waves, Computers and Geosciences, vol. 107, pp. 28-36, 2017 DOI: 10.1016/j.cageo.2017.07.001.

This method enables automatic retrieval of the extrinsic parameters of the stereoscopic platform (necessary to reconstruct the free surface elevation), so that it is not necessary to perform a calibration directly on the marine site, or an intrinsic calibration using a reference target (an object sufficiently large to be seen by both cameras). Some adaptations may be required regarding the calibration of a purely stationary stereoscopic system (for example, for flying the drone at different altitudes, a different calibration can be provided for each flight altitude).

### 4) Calibrating the Free Surface Elevation Reconstruction Model

This step calibrates the free surface elevation reconstruction model built in step 1 by use of the localized free surface elevation measurement performed in step 3. The free surface elevation reconstruction model is adapted in such a way that, at the measuring points, the free surface elevation measurement is coherent with the output of the free surface elevation reconstruction model. The calibration of the free surface elevation reconstruction model also takes into account the radar measurement performed in step 2 as model input to obtain the model output. As a result of this calibration, the calibrated free surface elevation reconstruction model is accurate at any point of the zone of interest.

As a reminder, this step can be carried out only once beforehand offline, or continuously online. For the offline implementation, the parameters of the free surface elevation reconstruction model can be determined using a large number of localized measurements covering a range of conditions (notably the meteorological conditions). The calibration methodology can then be carried out “ex-post” (i.e. after the measurement campaign) and be based on high-performance computing. For the online implementation, the free surface elevation reconstruction model can be such that its parameters can be adjusted in real time, according to the direct measurements performed by the drone(s).

For the embodiment where the free surface elevation reconstruction model depends on one parameter, calibration adapts this parameter to obtain coherence between the localized free surface elevation measurement and the output of the surface elevation reconstruction model at the measuring point. In this case, the free surface elevation reconstruction model can comprise one or more parameters, and their calibration finds the suitable parameters in order to obtain a free surface elevation as accurate as possible from the radar measurements. The best parameters depend, in full generality, on the characteristics of the radar, its adjustments, its installation, and on the characteristics of the sea state and of the atmosphere in the observed zone (included in the meteorological conditions).

The methodology of calibration of the free surface elevation reconstruction model depends on the free surface elevation reconstruction model considered, and on the implementation considered (offline or online).

According to a first example, for which the free surface elevation reconstruction model is built using a modulation transfer function (MTF), the method described in the following document can be applied:
Chen, Z., Zhang, B., He, Y. et al. (2015). A New Modulation Transfer Function for Ocean Wave Spectra Retrieval from X-Band Marine Radar Imagery. Chin. J. Ocean. Limnol. 33, 1132-1141 (2015).

For this method, a calibrated modulation transfer function is obtained by dividing the one-dimensional (1D) wavenumber spectrum estimated from the radar measurements by the 1D wavenumber spectrum estimated from free surface elevation spot measurements performed by a buoy. For the method according to the invention, the measurements obtained by the buoy are replaced with those performed by the drone, at the request of the measurement coordination system.

For other constructions of the free surface elevation reconstruction model, similar methods can be carried out.

### 5) Determining the Free Surface Elevation

This step applies the free surface elevation reconstruction model calibrated in step 4 to the radar measurement signal of step 2 in order to determine the free surface elevation of the water body zone. In other words, a free surface elevation is determined at any point of the zone of interest as output of the calibrated free surface elevation reconstruction model, which has a radar measurement signal as input.

For this step, the radar measurement signal used is an online measurement signal. Thus, to implement the offline calibration, the method uses an offline radar measurement for calibration of the model, and an online radar measurement for application of the calibrated model. Furthermore, for implementation of the online calibration, the method uses a continuous radar measurement.

The invention further concerns a system for determining a free surface elevation. Such a system comprises:
at least one radar;
at least one drone equipped with at least one sensor for remote free surface elevation measurement;
a control system for each drone; and
computing device (for example a computer, a server or a calculator, which comprises at least one processor and at least one memory) for implementing the method of determining the free surface elevation according to any one of the variants described above or any one of the variant combinations described above.

According to an embodiment, the method of determining the free surface elevation can comprise communications between the various devices. Concerning the data link systems, communication with at least one of the drone and its control and acquisition system can be done by radio waves. Communication between the radar, the computer system and the control system of each drone can be achieved through any kind of computer bus, including remote transmission. Preferably, the computer implementing the calibration can be designed to be physically close to the radar, notably for the large amount of data to be exchanged. Advantageously, the free surface elevation determined by the system can be normally shared on a computer communication bus, notably a computer communication bus connected to a system exploiting this measurement in real time or not (for example a system for monitoring, operation or control of a system subject to waves).

The invention further concerns a method for monitoring (supervision), operation or control, preferably a method for operation or control, of a system subject to waves (such as a floating platform or not, a ship, a wave-power system for example), wherein the following steps are carried out:
a) determining the free surface elevation of a zone of a water body by use of the method of determining the free surface elevation according to any one of the variants or variant combinations described above; and
b) controlling the system subject to waves according to the free surface elevation thus determined.

Thus, the method according to the invention allows monitoring, operation or control of a system subject to waves in order to increase the performance thereof and/or to limit the fatigue of the system subject to waves and/or to improve the feasibility and safety of a large number of sea operations.

According to an embodiment of the invention, the monitoring, operation or control method can comprise a step of predicting (in phase advance) the free surface elevation of the water body zone by use of the determined free surface elevation, and control is performed according to the free surface elevation prediction which anticipates control at the predicted future free surface elevation, before its arrival in the system to be monitored, operated or controlled.

The system subject to waves can notably be selected from among a ship, an aircraft carrier, an energy production platform (an oil platform for example), a renewable energy production system (an offshore wind turbine, a wave-power system for example), or a device enabling transfer of personnel or material at sea (gangway, crane), or any similar system.

The monitoring, operation or control step can notably be:
navigation of a ship in a zone where the free surface elevation is minimum, thus the ship can avoid severe sea conditions such as large waves;
stabilization of a floating platform or of a ship according to the free surface elevation;
and
control (predictive control for example) of a renewable energy production system in order to maximize the energy produced or to reduce the production system fatigue as a function of the free surface elevation:
   control of an electrical machine fitted in a wave-power system to optimize the power produced as a function of the swell height,
   control of the orientation angle of at least one of the blades and the nacelle of a wind turbine as a function of the waves and swell;
carrying out a sea operation when the free surface elevation is minimum, for example:
   rescue of a castaway from a ship;
   recovery of an object at the water surface from a ship;
   laying a marine or submarine object from a ship or a platform (a pipeline for example);
   aircraft take-off from or landing on an aircraft carrier, etc.; and
   transfer of personnel from a ship or a platform (offshore wind turbine maintenance for example).

### EXAMPLES

The features and advantages of the method according to the invention will be clear from reading the application example hereafter.

The purpose of the first example is to show the interest of a calibration using localized measurements. For this first example, a free surface elevation model via a modulation transfer function is used.

A reference surface elevation is simulated for a Gaussian sea with a JONSWAP type spectrum. The JONSWAP spectrum is an empirical relation that defines the wave energy distribution as a function of the frequency in deep water, which is particularly suited to the Northern Europe seas. This simulation is performed by superposing a large number of sine waves of different frequencies and direction, and with randomly chosen amplitudes and phases. The simulation duration is 10 minutes, with a time step of 1 second. The radial slope of the free surface elevation surface (relative to the direction of observation of the radar) is also calculated. From the reference free surface elevation and the radial slope thereof, a synthetic radar image (i.e. a simulated radar image) is formed from a model similar to that described in the following document:
Lyzenga, D. R., & Walker, D. T. (2015). A Simple Model for Marine Radar Images of the Ocean Surface. IEEE Geoscience and Remote Sensing Letters, 12(12), 2389-2392.

This model includes the tilt modulation, the shadow effect, the speckle noise, and a logarithmic signal amplification.

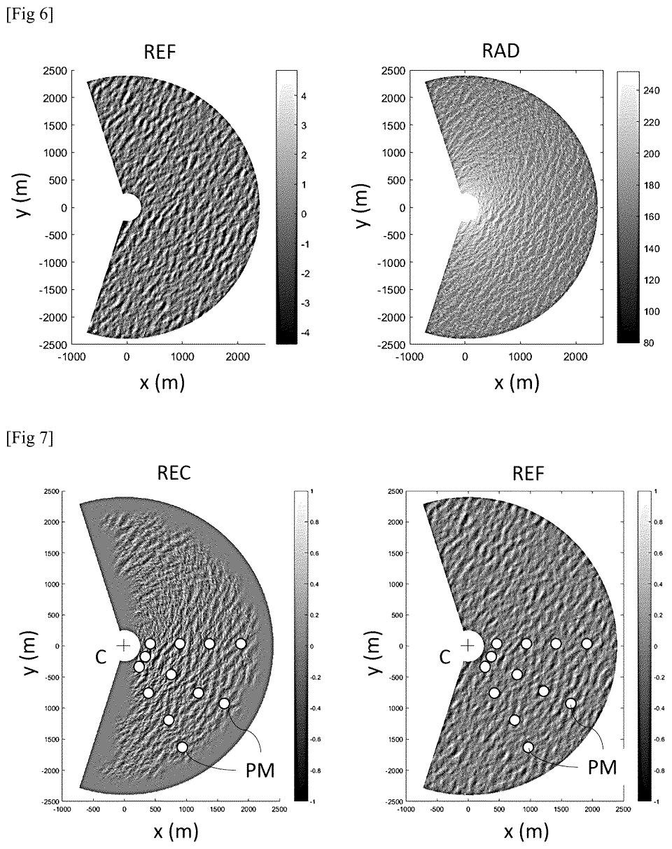

FIG. 6 schematically illustrates, by way of non-limitative example, reference free surface elevation REF and radar image RAD in a system of coordinates x,y. For reference free surface elevation REF, the grayscale indicates the water height. For radar image RAD, the grayscale indicates the signal measured by the radar and digitized using 8 bits (therefore ranging between 0 and 255).

The free surface elevation reconstruction model is subsequently used by using the average modulation transfer function (method according to the prior art) to reconstruct the free surface elevation using the radar image.

FIG. 7 schematically illustrates, by way of a non-limitative example, the reconstructed (according to the method of the prior art with an average modulation transfer function) free surface elevation REC and reference free surface elevation REF. It is noted that the reconstruction according to the method of the prior art is not totally accurate.

Three series of points PM for which the modulation transfer function is determined are identified in this figure. These points are referenced in system (x,y) as a function of the distance to the centre C (x=0 and y=0) and of an angle with respect to the line y=0.

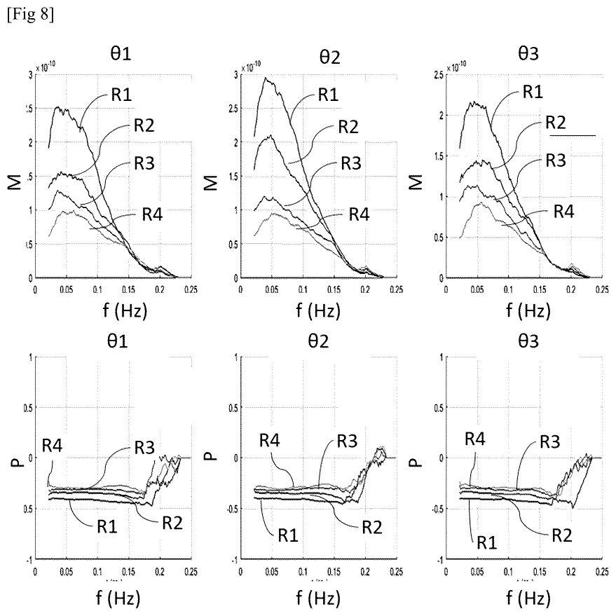

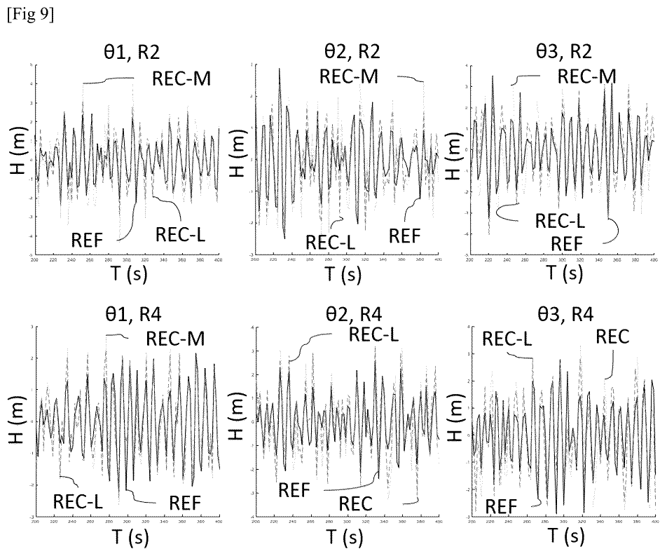

FIG. 8 illustrates the modulus M and the phase P of the modulation transfer function as a function of frequency f in Hz, for these points PM of FIG. 7. The left curves correspond to an angle θ1 of 600 with respect to the line y=0, the curves at the centre correspond to an angle θ2 of 30° with respect to the line y=0, and the right curves correspond to an angle θ3 of 0° with respect to the line y=0. References R1 to R4 designate the distance to the centre C of the system, with R1=600 m, R2=1000 m, R3=1400 m, and R4=1800 m.

It is noted that the curves vary greatly from one point to the other. Therefore, application of a method according to the prior art with an average modulation transfer function does not allow to accurately obtaining the swell spectrum or, a fortiori, an accurate “wave by wave” reconstruction of the free surface elevation of the zone of interest.

Furthermore, it can be observed that the modulation transfer function has variations that are relatively regular as a function of distance and azimuth (here, for example, the slope and the amplitude of the transfer function decrease with the distance).

With the method according to the invention, by flying the drone at several well-selected distances and azimuths, for a few minutes in each location, it is possible to calibrate the parameters of a simple model of the spatial variations of the modulation transfer function, and thus to accurately exploit the radar images over large surfaces.

For the second example, a free surface elevation reconstruction is carried out using local transfer functions obtained by averaging the transfer function in a 100-m radius around each point PM, and by comparing it with the reconstruction obtained with an average transfer function.

The inverse of the transfer function: either the local transfer function corresponding to the zone around the point considered, or the average transfer function, is then applied to the reconstructed free surface elevation (whose diagram REC shows a representation at a given time) at each of the twelve points PM defined above in FIG. 7.

FIG. 9 shows the free surface elevation time series H in m thus reconstructed as a function of time T in s, for the six points, respectively 1000 m and 1800 m away from the radar for angles θ1, 02, 03. The series designated by REC-L are those obtained from the local transfer functions, while those obtained with the average transfer function are designated by REC-M. The reference time series are designated by REF. It is noted that the signal amplitudes are rather different.

Table 1 shows for the six points, respectively at R2=1000 and R4=1800 m from the radar for angles θ1, 02, 03, the mean squared errors between the reconstructions by local (ERR-REC-L) and global (ERR-REC-M) transfer function and the reference free surface elevation.

TABLE 1

| | θ1, R2 | θ2, R2 | θ3, R2 | θ1, R4 | θ2, R4 | θ3, R4 |
|---|---|---|---|---|---|---|
| ERR- | 0.4763 | 0.5302 | 0.5531 | 0.6027 | 0.6666 | 0.6813 |
| REC-L | | | | | | |
| ERR- | 0.7365 | 0.6572 | 0.6660 | 0.7064 | 0.9483 | 0.9640 |
| REC-M | | | | | | |

Reconstructions by local transfer function are clearly more accurate. Thus, the method according to the invention allows determination of the free surface elevation in relation to a method using a constant modulation transfer function.

1-10. (canceled)

11. A method of determining a free surface elevation of a water body zone using radar and at least one drone each equipped with a sensor providing remote measurement of the free surface elevation, comprising the steps of:
a. constructing a free surface elevation reconstruction model relating a signal measured by the radar to the free surface elevation;
b. measuring with radar a signal representative of the free surface elevation of the water body zone;
c. performing at least one measurement during flying of the at least one drone with the at least one sensor fitted to the at least one drone at a measuring point in the water body zone;
d. using the at least one measurement to calibrate the free surface elevation reconstruction model; and
e. applying the signal representative of the free surface elevation measured at the measuring point with the radar to the calibrated free surface elevation model to determine the surface elevation at the measuring point of the water body zone.

12. A method as claimed in claim 11, wherein the at least one measuring point is a function of the signal measured by the radar.

13. A method as claimed in claim 11, comprising acquiring at least one meteorological condition and wherein the free surface elevation reconstruction model is a function of the at least one meteorological condition selecting with at least one meteorological condition being selected from wind speed, wind direction, rainfall, temperature and a sea state of the water body zone.

14. A method as claimed in claim 12, comprising acquiring at least one meteorological condition and wherein the free surface elevation reconstruction model is a function of the at least one meteorological condition and selecting with at least one meteorological condition being selected from wind speed, wind direction, rainfall, temperature and a sea state of the water body zone.

15. A method as claimed in claim 11, wherein the sensor in each of the at least one drones is selected from a LiDAR sensor, a thermal camera, an optical camera, and a vertical-beam radar.

16. A method as claimed in claim 12, wherein the sensor in each of the at least one drones is selected from a LiDAR sensor, a thermal camera, an optical camera and a vertical-beam radar.

17. A method as claimed in claim 13, wherein the sensor in each of the at least one drones is selected from a LiDAR sensor, a thermal camera, an optical camera, and a vertical-beam radar.

18. A method as claimed in claim 14, wherein the sensor in each of the at least one drones is selected from a LiDAR sensor, a thermal camera, an optical camera, and a vertical-beam radar.

19. A method as claimed in claim 11, wherein the free surface elevation reconstruction model uses one of a modulation transfer function, an assimilation method, a machine learning method or a deep learning method.

20. A method as claimed in claim 12, wherein the free surface elevation reconstruction model uses one of a modulation transfer function, an assimilation method, a machine learning method or a deep learning method.

21. A method as claimed in claim 13, wherein the free surface elevation reconstruction model uses one of a modulation transfer function, an assimilation method, a machine learning method or a deep learning method.

22. A method as claimed in claim 14, wherein the free surface elevation reconstruction model uses one of a modulation transfer function, an assimilation method, a machine learning method or a deep learning method.

23. A method as claimed in claim 11, comprising flying the at least one drone, performing offline calibration of the free surface reconstruction model, and applying on line the calibrated free surface elevation reconstruction model to a signal measured by the radar online.

24. A method as claimed in claim 11, wherein the flying of the at least one drone and online calibration are carried out continuously to calibrate the free surface elevation reconstruction model.

25. A method as claimed in claim 11, wherein free surface elevation is determined in real time.

26. A system for determining the free surface elevation of a water body zone using the method claimed in claim 11, comprising at least one radar, at least one drone equipped with at least one sensor for remote free surface elevation measurement, a system for flying the at least one drone and a computer for implementing the method for determining the free surface elevation.

27. A method of monitoring, operating or controlling a system subject to waves within a water body zone, comprising steps of:
a. determining free surface elevation of the zone of a water body by determining the free surface elevation using the method claimed in claim 11; and
b. supervising, operating or controlling the system subject to waves as a function of the determining free surface elevation of the water body zone.

28. A method as claimed in claim 13, wherein the free surface elevation reconstruction model uses one of a modulation transfer function, an assimilation method, a machine learning method or a deep learning method.

29. A method as claimed in claim 14, wherein the free surface elevation reconstruction model uses one of a modulation transfer function, an assimilation method, a machine learning method or a deep learning method.

30. A method as claimed in claim 15, wherein the free surface elevation reconstruction model uses one of a modulation transfer function, an assimilation method, a machine learning method or a deep learning method.
